(19) United States
(12) Patent Application Publication
(10) Pub. No.: US 2018/0308057 A1
(43) Pub. Date: Oct. 25, 2018

(54) JOINT OPTIMIZATION AND ASSIGNMENT OF MEMBER PROFILES

(71) Applicant: Linkedln Corporation, Sunnyvale, CA (US)

(72) Inventors: Krishnaram Kenthapadi, Sunnyvale, CA (US); Fedor Vladimirovich Borisyuk, Sunnyvale, CA (US)

(21) Appl. No.: 15/493,699

(22) Filed: Apr. 21, 2017

(51) Int. Cl. G06Q 10/10; G06Q 50/00

(52) U.S. Cl. CPC G06Q 10/1053; G06Q 50/01

(57) ABSTRACT

An on-line social network system includes or is in communication with a recommendation system that is configured to assign members to jobs while taking into account fitness of a member for the job, as well as the relevance of that job for that given member, as well as the relevance of the same job for other members. The objective of said optimization is to maximize the total sum of respective relevance scores generated for member/job pairs for members that get selected for presentation to posters of jobs. The optimization objective is constrained by the maximum number of job recommendations desirable for each member profile and may also be constrained by the maximum number of member recommendations desirable for each job posting.

### TECHNICAL FIELD

This application relates to the technical fields of software and/or hardware technology and, in one example embodiment, to system and method to generate joint optimization and assignment of member profiles with respect to job postings in an on-line social network system.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member profile may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate joint optimization and assignment of member profiles with respect to job postings in an on-line social network system may be implemented;

FIG. 2 is block diagram of a system to generate joint optimization and assignment of member profiles with respect to job postings in an on-line social network system, in accordance with one example embodiment;

FIG. 3 is a flow chart illustrating a method to generate joint optimization and assignment of member profiles with respect to job postings in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate joint optimization and assignment of member profiles with respect to job postings in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application,” “an on-line social network system,” and “an on-line social network service” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profiles are stored in a database and represented by a set of features and also associated with respective web pages in the on-line social network system. A user may be permitted to add or edit information in their member profile by means of a profile user interface (UT) that includes a plurality of fields suitable for collecting input information. A member profile representing a member in an on-line social network system includes information items generated based on input provided via the profile UI. A member profile representing a member in an on-line social network system is also associated with information items generated based on events detected in the on-line social network system that indicate activity of the associated member in the on-line social network system the so-called behavior data.

A member profile may include or be associated with links that indicate the member's connection to other members of the social network. A member profile may also include or be associated with comments or recommendations from other members of the on-line social network, with links to other network resources, such as, e.g., publications, etc. The profile information of a social network member profile may include various information such as, e.g., the name of a member, current and previous geographic location of a member, current and previous employment information of a member, information related to education of a member, etc.

The on-line social network system also maintains information about various companies, as well as so-called job postings. A job posting, also referred to as merely “job” for the purposes of this description, is an electronically stored entity, that includes information that an employer may post with respect to a job opening. The information in a job posting may include, e.g., industry, company, job position, required and/or desirable skills, geographic location of the job, etc.

Member profiles and job postings are represented in the on-line social network system by feature vectors. The features in the feature vectors may represent, e.g., a job industry, a professional field, a job title, a company name, professional seniority, geographic location, etc.

The on-line social network system includes a recommendation system configured to select one or more job postings for presentation to a member based on criteria that indicates that a particular job posting is likely to be of interest to the member. The likelihood of a job being of interest to a member, in one embodiment, is expressed by the probability of the member applying for the associated job. The criteria that indicates that a particular job posting is likely to be of interest to the member, in one embodiment, is associated with a relevance value.

Those job postings, for which their respective relevance values for a particular member profile are equal to or greater than a predetermined threshold value, are selected for potential presentation to that particular member, e.g., on the news feed page of the member or on some other page provided by the on-line social networking system. Each item in a presentation set of job recommendations is a reference to a job posting that is associated with a relevance value generated for that job posting with respect to the particular member. The items in the presentation set of job recommendations may be ordered based on their respective associated relevance values.

While the recommendation system generates job recommendations for members, the recommendation system can also be configured to identify, with respect to a particular job posting, those members that are potentially qualified for the job. Thus it can be said that the recommendation system generates job recommendations with respect to a member profile and also generates member recommendations with respect to a job posting. Member recommendations for a job postings are selected based on their respective fitness values. A fitness value generated for a member profile with respect to a job posting indicates how qualified the member represented by the member profile is for the job represented by the job posting. A fitness value (also referred to as a fitness score), in one embodiment, is expressed as probability of a particular member being hired for a particular job and can be generated using a statistical model (referred to as a fitness model for the purposes of this description), such as, e.g., logistic regression. A fitness model can be learned using previously collected data that is indicative of members' features expressed in their respective member profiles and the status of the members' being hired for various jobs represented by respective job postings.

Those member profiles, for which their respective fitness values for a particular job posting are equal to or greater than a predetermined threshold value, are selected for potential presentation to a job poster (a user associated with providing of the job posting to the on-line social network system), e.g., via email or push notification, etc. Each item in a resulting presentation set of member profiles is a reference to a member profile.

It will be noted that, for the purposes of this description, when discussing items in a presentation set of job recommendations or items in a presentation set of profiles, the phrase “member” or “member profile” refers to a reference to a member profile, and the phrase “job” or “job posting” refers to a reference to a job posting.

As the number of jobs potentially relevant to a member may be too large for the presentation real estate and the member's attention span, the recommendation system uses a cap value r(m) (termed a jobs cap value) that limits the maximum number of jobs that can be included in a presentation set of job recommendations for a particular member profile m. For the purposes of this description, a member profile is sometimes referred to as merely member. Also, the number of member profiles to be recommended with respect to a particular job posting j is limited by a so-called candidates cap value, s(j) such that the number of items that can be included in a presentation set of profiles is less than or equals to that value. Each item in a presentation set of job recommendations is a reference to a job posting that is associated with a relevance value generated for that job posting with respect to the particular member. The items in the presentation set of job recommendations may be ordered based on their respective associated relevance values. Each item in a presentation set of profiles generated for a particular job posting is a reference to a member profile that is associated with a fitness value generated for that member profile with respect to the particular job postings. The items in the presentation set of profiles may be ordered based on their respective associated fitness values.

One approach for determining which job postings to recommend to a job poster is to identify a set of candidate members for a subject posting (those member profiles that pass a certain minimal threshold of professional fitness for the job, which may be, e.g., the members employed in the same industry as the subject job posting and having a at least some skills matching the skills required by the job), calculate respective fitness scores for all these jobs with respect to the subject member, and pick a certain number of member profiles with the highest fitness scores for presentation to the job poster. It may be desirable to not show too many, member profiles to a job posters, as it may be more difficult for an employer to make a choice among the job candidates when there are too many applications while some of the associated members may not even be interested enough in the job to actually apply for the job.

A further approach for determining which member profiles to show to a job poster is a so-called simultaneous optimization-based assignment, which takes into account how qualified the member is for the job (based on the associated fitness score), as well as the relevance of the job for that member, as well as the relevance of the same job for other members.

The objective of said optimization is to maximize the total sum of respective relevance scores generated for member/job pairs for member profiles included in the respective sets of candidate members that get selected for presentation to job posters. Such optimization problem can be expressed as Equation (1) below.

$$max {\sum }_{j ∈ J}^{ } {\sum }_{m ∈ M}^{ } [ x ( m , j ) * α ( m , j ) ] \qquad Equation ( 1 )$$

where M denotes the set of members m, and J denotes the set of jobs j, α(m, j) is the relevance score generated for a pair comprising member m and job j, and x(m, j) is an indicator variable that takes value 1 if member in is assigned to job j, and 0 otherwise. If a member profile m has not been included in a set for potential presentation to a job poster with respect to a job posting j (based, e.g., on the fitness value generated for that member profile with respect to that job posting being equal to or greater than a predetermined threshold value), the relevance score for that pair, (m, j), is set to zero.

The optimization objective is constrained by the maximum number of job recommendations, r(m), desirable for each member profile m, which can be expressed by Equation (2) shown below.

Σ_{j∈J}x(m,j)≤r(m) Equation (2)

The optimization objective is also constrained by the maximum number of member recommendations, s(j) desirable for each job posting j, which can be expressed by Equation (3) shown below.

Σ_{m∈M}x(m,j)≤s(j) Equation (3)

The optimization problem expressed by Equation (1) is solved by computing, for all the (m, j) pairs, respective binary variables x(m, j), such that the total relevance score, defined as the sum of relevance scores of assigned (member, job) pairs, is maximized. A (member, job) pair is said to be assigned if the member profile from the pair has been selected for presentation to the poster of a job represented by the job posting from that pair. In other words, the value of an x(m, j) variable determines whether the member profile m is selected for recommendation and presentation to the job poster of the job j.

In operation, the recommendation system takes, as input, (1) the maximum number of job recommendations, r(m), desirable for each member profile in, (2) the maximum number of member recommendations, s(j) desirable for each job posting j, and (3) the time period, deltaT, between two adjacent joint computations.

At time t, for each job posting j, the recommendation system determines H(j), candidate set of member profiles, along with the respective relevance scores α(m, j), as follows. It first obtains a preliminary set of member profiles, using, e.g., the feature comparison approach. The recommendation system then generates respective fitness values for each member profile in the preliminary set using the fitness model and eliminates from that set those member profiles, for which the fitness score is equal to or less than a predetermined threshold value. The recommendation system next returns the resulting set of job postings with corresponding relevance scores α(m, j).

The recommendation system then executes one or more operations for solving the optimization problem expressed by Equation (1) in order to compute, for all the (m, j) pairs from the set of members M and the set of jobs J, respective binary variables x(m, j), such that the total relevance score, defined as the sum of relevance scores of assigned (member, job) pairs, is maximized. Thus, the recommendation system uses fitness values to trim down the preliminary set of member profiles and next uses relevance values to determine the final assignment of member profiles to job postings.

The optimization problem expressed by Equation 1 can be solved utilizing, e.g., the optimal algorithm or, e.g., the greedy algorithm. The process of executing of the optimal algorithm comprises reducing the above optimization problem to the maximum weighted bipartite matching problem, which admits an efficient polynomial time solution. A maximum weighted bipartite matching is defined as a matching where the sum of the values of the edges in the matching have a maximal value. Finding such a matching can be referred to as the assignment problem. Given an instance of the above problem, the recommendation system forms a complete weighted bipartite graph G=(V, E) as follows. Associate r(m) nodes u_{m, 1}, . . . , u_{m, r(m)} with each member m in M, and associate s(j) nodes v_{j, 1}, . . . , v_{j, s(j)} with each job j in J. Create an edge between every member node copy and every job node copy. Weight of the edge (u_{m, *}, v_{j, *}) is set to α(m, j) for all r(m)*s(j) such edges; that is, each of the edges joining a member m to job j has the same weight, equal to the corresponding relevance score α(m, j). The recommendation system performs operations for solving the maximum weighted bipartite matching problem optimally in polynomial time, and maps the obtained matching to the corresponding solution to the above problem where the obtained matching corresponds to the set of x(m, j) from M and J having the value 1 indicating that the member m is assigned to job j.

Another example approach to solving the optimization problem expressed by Equation 1 is the greedy algorithm. The process of executing of the greedy algorithm comprises sorting the α(m, j) values in decreasing order and parsing these values. At each step, the greedy algorithm picks the highest α(m, j) value such that a member can still be assigned to job j (that is, less than s(j) members have so far been assigned to j) and then assigns member m to job j. This process ends when either all jobs have been assigned the maximum number of members or there are no more members to be assigned.

For the purpose of computational efficiency, in some embodiments, the recommendation system can partition member profiles and job postings based on, e.g., on industry, job function, geographic location, etc. or a combination of these dimensions, and consider separate optimizations within each partition.

The process of simultaneous optimization and assignment of member profiles to jobs can be repeated at intervals of deltaT in order to take into account the temporal nature of members and jobs (new members/members who updated their profiles/new jobs/expired jobs/edited jobs). Between a computation and the next one, the preliminary sets of member recommendations are computed for each job posting separately, using the fitness model.

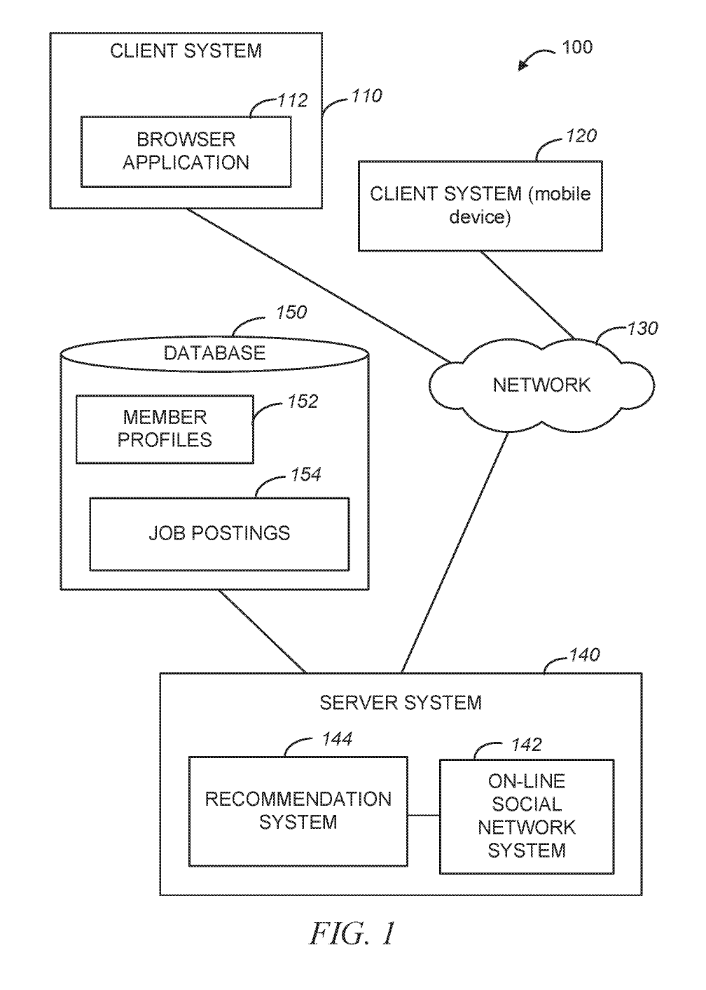

An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154.

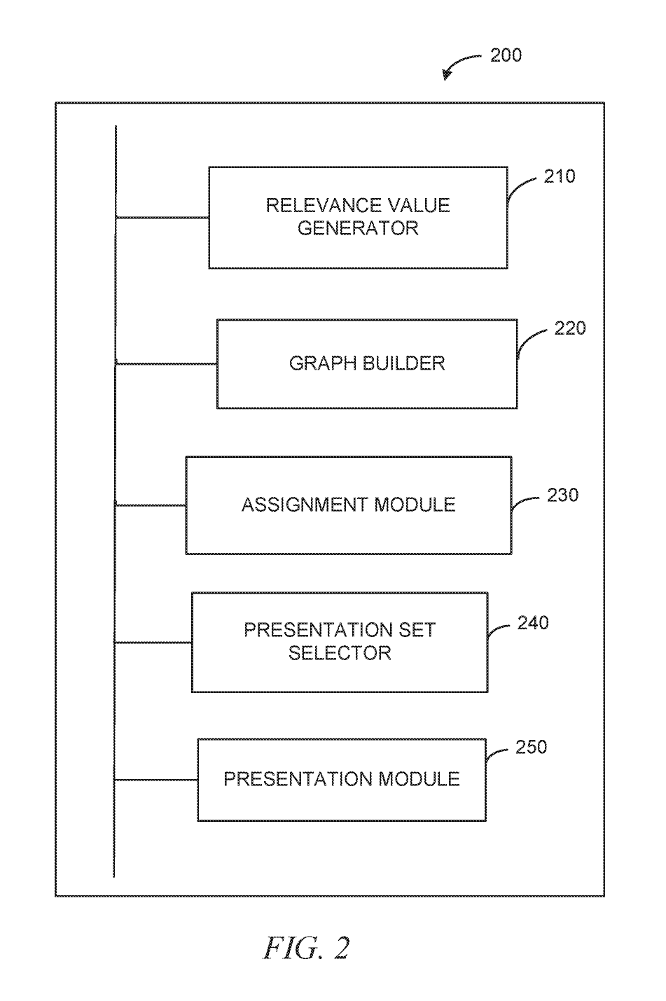

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 is configured to perform simultaneous optimization-based assignment of member profiles to job postings, while taking into account fitness of a member for the job, as well as the relevance of that job for that given member, as well as the relevance of the same job for other members, using the methodologies described above. An example of an on-line social network system is LinkedIn®. An example recommendation system, which corresponds to the recommendation system 144 is illustrated in FIG. 2.

FIG. 2 is a block diagram of a system 200 to generate joint optimization and assignment of member profiles with respect to job postings in the on-line social network system 142 of FIG. 1. As shown in FIG. 2, the system 200 includes a relevance value generator 210, a graph builder 220, an assignment module 230, a presentation set selector 240, and a presentation module 250.

The relevance value generator 210 is configured to generate, for pairs comprising a member profile from the set of member profiles and a job posting from the set of job postings. The graph builder 220 is configured to construct a weighted bipartite graph with nodes representing member profiles from a set of member profiles and job postings from a set of job postings, where an edge associated with a node representing a member profile and a node representing a job posting has a weight reflecting a respective relevance value generated for a pair comprising that member profile and that job posting. The relevance value generator 210, in some embodiments, e.g., when used in the process of assigning member profiles to job postings based on respective members' potential fitness for the associated job, is configured to determine that a fitness value associated with a member profile and a particular job posting is equal to or less than a predetermined threshold value (or that the member profile is not included in the preliminary assignment set for that particular job posting based on the associated fitness value) and, based on that determination, assigns a zero value to a relevance value associated with the pair comprising that member profile and that particular job posting. As explained above, the fitness value indicates a likelihood that a member represented by a certain member profile is hired for a job represented by a certain job posting.

The assignment module 230 is configured to produce an assignment set by calculating, with respect to the constructed weighted bipartite graph, a maximum weighted bipartite matching comprising resulting edges, and representing the resulting edges as the assignment set comprising pairs made of a member profile and a job posting. The presentation set selector 240 is configured to generate a presentation set for a subject job posting from the set of job postings, where the items in the presentation set represent member profiles from those pairs from the assignment set that include the subject job posting. The presentation set selector 240 can also be configured to determine that the binary value assigned to a pair comprising the subject job posting and a particular member profile is indicative of positive assignment and, based on the binary value, include, into the presentation set, an item representing the particular member profile. Conversely, the presentation set selector 240 can also be configured to determine that the binary value assigned to a pair comprising the subject job posting and a particular member profile is not indicative of positive assignment and, based on the binary value, omit an item representing the particular member profile from being included into the presentation set. The presentation module 250 is configured to cause presentation, on a display device, of a reference to a member profile from the presentation set.

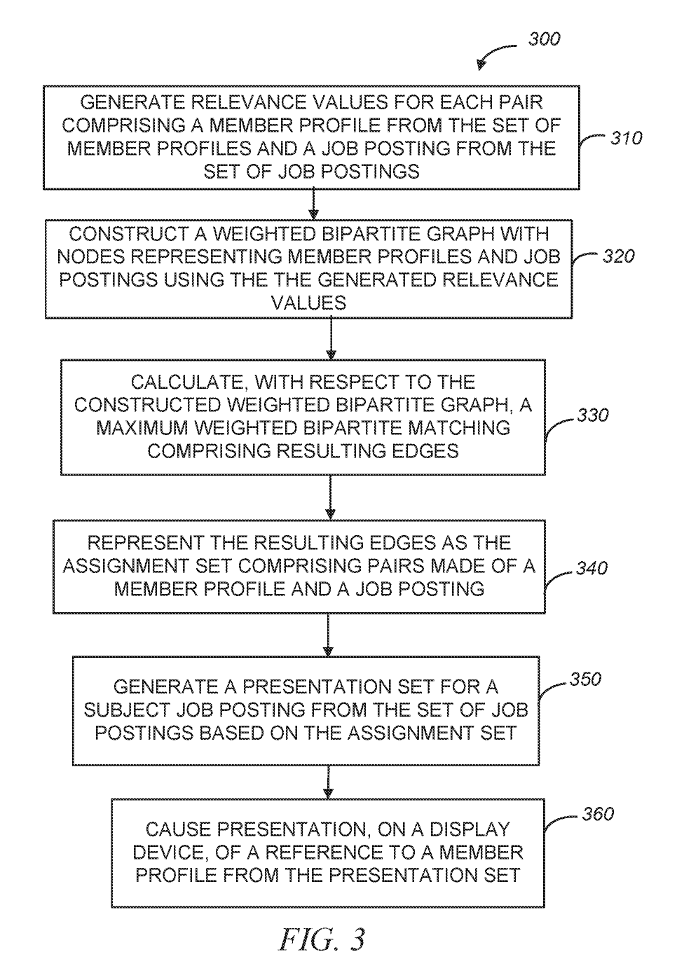

The system 200, in some embodiments, also includes an indicator value generator (not shown) to generate, for each pair comprising a member profile from the set of member profiles and a job posting from the set of job postings, a binary value indicating whether the associated member profile is assigned to the associated job posting. The presentation set selector 240 may be configured to generate a presentation set for a subject job posting based on the binary values generated by the indicator value generator. In some embodiments, the indicator value generator is implemented as part of the assignment module 230. Some operations performed by the system 200 may be described with reference to FIG. 3.

FIG. 3 is a flow chart of a method 300 to generate joint optimization and assignment of member profiles with respect to job postings in the on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the relevance value generator 210 of FIG. 2 generates, for each pair comprising a member profile from a set of member profiles and a job posting from the set of job postings, an associated relevance value indicating a likelihood that a member represented by a member profile applies for a job represented by a job posting. At operation 320, the graph builder 220 of FIG. 2 constructs a weighted bipartite graph with nodes representing member profiles from the set of member profiles and job postings from the set of job postings. An edge associated with a node representing a member profile and a node representing a job posting having a weight reflecting a respective relevance value generated for a pair comprising that member profile and that job posting. The assignment module 230 of FIG. 2 calculates, with respect to the constructed weighted bipartite graph, a maximum weighted bipartite matching comprising resulting edges at operation 330 and represents the resulting edges as the assignment set comprising pairs made of a member profile and a job posting, at operation 340. At operation 350, the presentation set selector 240 of FIG. 2 generates a presentation set for a subject job posting from the set of job postings, where items in the presentation set represent member profiles from those pairs from the assignment set that include the subject job posting. The presentation module 250 of FIG. 2 causes presentation, on a display device, of a reference to a member profile from the presentation set, at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

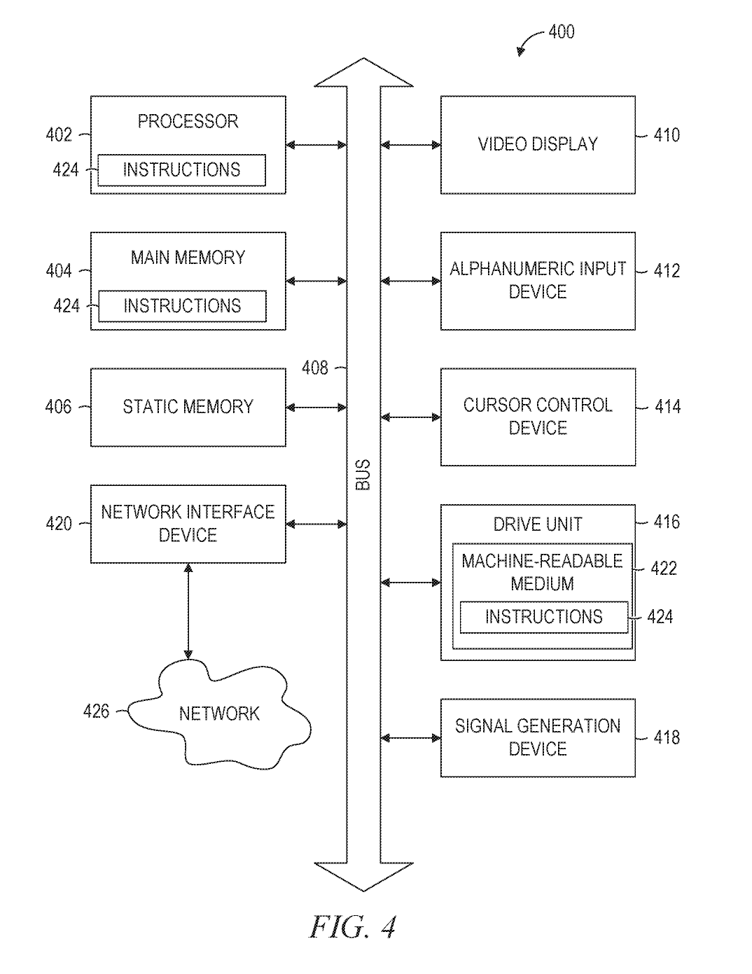

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer distributed) network environment. The machine may be a personal computer (PC), a tablet PC, a set-top box (STB), a Personal Digital Assistant (PDA), a cellular telephone, a web appliance, a network router, switch or bridge; or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCI)) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically, constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially, processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate joint optimization and assignment of member profiles with respect to job postings in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
maintaining a set of job pas s representing respective jobs in an on-line social network system;
maintaining a set of member profiles representing respective members in the on-line social network system;
generating, for each pair comprising a member profile from the set of member profiles and a job posting from the set of job postings, an associated relevance value indicating a likelihood that a member represented by a member profile applies for a job represented by a job posting;
using at least one processor, constructing a weighted bipartite graph with nodes representing member profiles from the set of member profiles and job postings from the set of job postings, an edge associated with a node representing a member profile and a node representing a job posting having a weight reflecting a respective relevance value generated for a pair comprising that member profile and that job posting;
calculating, with respect to the constructed weighted bipartite graph; a maximum weighted bipartite matching comprising resulting edges and representing the resulting edges as an assignment set comprising pairs made of a member profile and a job posting;
generating a presentation set for a subject job posting from the set of job postings, items in the presentation set representing member profiles from those pairs from the assignment set that include the subject job posting; and
causing presentation, on a display device, of a reference to a member profile from the presentation set.

2. The method of claim 1, wherein the generating of associated relevance values for each pair comprising a member profile from the set of member profiles and a job posting from the set of job postings comprises:
determining that a fitness value, the fitness value indicating a likelihood that a member represented by a certain member profile is hired for a job represented by a certain job posting, is equal to or less than a predetermined threshold value; and
assigning a zero value to a relevance value associated with the pa comprising the certain member profile and the certain job posting.

3. The method of claim 1, comprising generating, for each pair comprising a member profile from the set of member profiles and a job posting from the set of job postings, a binary value indicating whether the associated member profile is assigned to the associated job posting.

4. The method of claim 3, comprising:
determining that the binary value assigned to a pair comprising the subject job posting and a particular member profile is indicative of positive assignment; and
based on the determining including, into the presentation set, an item representing the particular member profile.

5. The method of claim 3, comprising:
determining that the binary value assigned to a pair comprising the subject job posting and a particular member profile indicates that the particular member profile is not assigned to the subject job posting; and
based on the determining omitting an item representing the particular member profile from inclusion into the presentation set.

6. The method of claim 1, wherein a number of nodes representing the subject job posting in the constructed weighted bipartite graph equals a predetermined candidates cap value.

7. The method of claim 1, wherein a number of nodes representing a particular member profile in the constructed weighted bipartite graph equals a predetermined jobs cap value.

8. The method of claim 1, wherein each job posting in the set of job postings is associated with a particular industry.

9. The method of claim 1, wherein each member profile from the set of member profiles is associated with a profile UI configured to display and to collect data about the associated member.

10. The method of claim 1, wherein each job posting in the set of member profiles is an electronic publication in a structured form.

11. A computer-implemented system comprising:
one or more databases storing a set of job postings representing respective jobs in an on-line social network system and a set of member profiles representing respective members in the on-line social network system;
a relevance value generator, implemented using at least one processor, to generate, for each pair comprising a member profile from the set of member profiles and a job posting from the set of job postings, an associated relevance value indicating a likelihood that a member represented by a member profile applies for a job represented by a job posting;
a graph builder, implemented using at least one processor, to construct a weighted bipartite graph with nodes representing member profiles from the set of member profiles and job postings from the set of job postings, an edge associated with a node representing a member profile and a node representing a job posting having a weight reflecting a respective relevance value generated for a pair comprising that member profile and that job posting;
an assignment module, implemented using at least one processor, to produce an assignment set by:
calculating, with respect to the constructed weighted bipartite graph, a maximum weighted bipartite matching comprising resulting edges, and
representing the resulting edges as the assignment set comprising pairs made of a member profile and a job posting;
a presentation set selector, implemented using at least one processor, to generate a presentation set for a subject job posting from the set of job postings, items in the presentation set representing member profiles from those pairs from the assignment set that include the subject job posting; and
a presentation module, implemented using at least one processor, to cause presentation, on a display device, of a reference to a member profile from the presentation set.

12. The system of claim 11, wherein the relevance value generator is to:
determine that a fitness value, the fitness value indicating a likelihood that a member represented by a certain member profile is hired for a job represented by a certain job posting, is equal to or less than a predetermined threshold value; and
assign a zero value to a relevance value associated with the pair comprising the certain member profile and the certain job posting.

13. The system of claim 11, comprising an indicator value generator, implemented using at least one processor, to generate, for each pair comprising a member profile from the set of member profiles and a job posting from the set of job postings, a binary value indicating whether the associated member profile is assigned to the associated job posting.

14. The system of claim 13, wherein the presentation set selector is to:
determine that the binary value assigned to a pair comprising the subject job posting and a particular member profile is indicative of positive assignment; and
based on the determining include, into the presentation set, an item representing the particular member profile.

15. The system of claim 13, wherein the presentation set selector is to:
determine that the binary value assigned to a pair comprising the subject job posting and a particular member profile indicates that the particular member profile is not assigned to the subject job posting; and
based on the determining omit an item representing the particular member profile from inclusion into the presentation set.

16. The system of claim 11, wherein a number of nodes representing the subject job posting in the constructed weighted bipartite graph equals a predetermined candidates cap value.

17. The system of claim 11, wherein a number of nodes representing a particular member profile in the constructed weighted bipartite graph equals a predetermined jobs cap value.

18. The system of claim 11, wherein each job posting in the set of job postings is associated with a particular industry.

19. The system of claim 11, wherein each member profile from the set of member profiles is associated with a profile UI configured to display and to collect data about the associated member.

20. A machine-readable non-transitory storage medium having instruction data executable by a machine to cause the machine to perform operations comprising:
maintaining a set of job postings representing respective jobs in an on-line social network system;
maintaining a set of member profiles representing respective members in the on-line social network system;
generating, for each pair comprising a member profile from the set of member profiles and a job posting from the set of job postings, an associated relevance value indicating a likelihood that a member represented by a member profile applies for a job represented by a job posting;
constructing a weighted bipartite graph with nodes representing member profiles from the set of member profiles and job postings from the set of job postings, an edge associated with a node representing a member profile and a node representing a job posting having a weight reflecting a respective relevance value generated for a pair comprising that member profile and that job posting;
calculating, with respect to the constructed weighted bipartite graph, a maximum weighted bipartite matching comprising resulting edges and representing the resulting edges as an assignment set comprising pairs made of a member profile and a job posting;
generating a presentation set for a subject job posting from the set of job postings, items in the presentation set representing member profiles from those pairs from the assignment set that include the subject job posting; and
causing presentation, on a display device, of a reference to a member profile from the presentation set.
